(19) United States
(12) Patent Application Publication
(10) Pub. No.: US 2019/0039258 A1
(43) Pub. Date: Feb. 7, 2019

(54) Multi Saw Machine Modular Type System

(71) Applicant: Chao-Ying LEE, Riverside, CA (US)

(72) Inventor: Chao-Ying LEE, Riverside, CA (US)

(73) Assignee: Sawmaster Diamond Tools, Inc., Riverside, CA (US)

(21) Appl. No.: 16/056,547

(22) Filed: Aug. 7, 2018

Related U.S. Application Data
(60) Provisional application No. 62/541,716, filed on Aug. 6, 2017.

(51) Int. Cl. B27B 5/18; B27G 19/02; B27B 5/20; B27B 9/04

(52) U.S. Cl. CPC B27B 5/187; B27B 9/04; B27B 5/201; B27G 19/02

(57) ABSTRACT

A saw machine system includes a modular saw machine and a plurality of saw machine implements, wherein the modular saw machine is selectively coupled to the saw machine implements to transform one type of saw machine to another saw machine. By selectively coupling the modular saw machine to the saw machine implement, the saw machine system becomes one of a portable hand-held saw machine, a fixed cutting-head saw machine, and a cutting-head guide-by-rail saw machine.

### CROSS REFERENCE OF RELATED APPLICATION

This is a non-provisional application that claims priority to U.S. provisional application, provisional application No. 62/541,716, filed Aug. 6, 2017, the entire contents of each of which are expressly incorporated herein by reference.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to a saw machine, in particular to a modular saw machine and one or more implements that can be quickly mounted thereon. By designing the saw machine to interchange with different type of implements, one machine can function as a portable hand-held, fixed cutting-head, or cutting-head guide-by-rail saw system.

### Description of Related Arts

Conventional cutting machines are widely used in various industries for provision of rapid and high quality cutting of such construction and manufacturing materials of work pieces as granite, marble, slate, pave, brick, ceramics, and masonry. Accordingly, there are many different types of cutting machines available depending on the cutting needs. Using the wrong type of cutting machine, could result in ruining the cutting machine and the work piece.

FIG. 5 illustrates a conventional fixed-head saw machine 51 which comprises a cutting head 52 suspended and affixed above a station, wherein the work piece is supported on the station and is cut by the cutting head 52. The cutting head 52 comprises a cutting tool guard 521, a cutting tool 522, and a driving motor 523 located behind the cutting tool 522. Accordingly, the conventional fixed-head saw machine 51 is relatively large and heavy, especially the cutting head 52. Since the cutting head 52 is fixed on the station that the cutting head 52 cannot be detached from the station, the conventional fixed-head saw machine 51 requires a relatively larger storage space for storage and transportation.

FIG. 7 illustrates a conventional cutting-head guide-by-rail saw machine 71, which comprises a cutting head 722, a cutting table frame 723, a cutting table 724, and a cutting head guide rail 725. The cutting head 722 comprises a cutting tool 7222 driven by a driving motor 7223. The cutting table 724 is supported on the cutting table frame 723 to support the work piece 721 on the cutting table 724. The cutting head guide rail 725 is suspended and supported above the cutting table 724. The cutting head 722 is slidably coupled at the cutting head guide rail 725, wherein the cutting head 722 is slid at and guided by the cutting head guide rail 725 to cut the work piece 721 on the cutting table 724. The major drawback of the conventional cutting-head guide-by-rail saw machine 71 is that the size thereof is relatively large comparing with the conventional fixed-head saw machine 51. In particular, a head portion of the cutting head 722 is coupled at the cutting head guide rail 725, such that the distance between the cutting head guide rail 725 and the cutting table 724 must be large enough to accommodate the cutting head 722. In other words, the sliding movement of the cutting head 722 via the cutting head guide rail 725 is unstable via the elevated height. Furthermore, the work piece 721 cannot be stably placed on the cutting table 724 and will be pushed by the cutting head 722 when the cutting head 722 is slid along the cutting head guide rail 725 during the cutting operation.

Accordingly, in order to complete a construction work, the operator must carry different saw machines for different cutting needs. In other words, the operator must carry the conventional fixed-head saw machine 51 and the conventional cutting-head guide-by-rail saw machine 71 for different cutting needs. In addition, a portable saw machine is a must for the operator. It is hassle for the operator to carry and transport different saw machines from place to place, and assemble and disassemble the different saw machines for every construction work.

### SUMMARY OF THE PRESENT INVENTION

The invention is advantageous in that it provides a modular saw machine, wherein different implements are interchangeable to provide different cutting needs.

Another advantage of the invention is to a modular saw machine, wherein one machine can function as a portable hand-held, fixed cutting-head, or cutting-head guide-by-rail saw system.

Another advantage of the invention is to a modular saw machine, which is a cost-effective and all-in-one saw machine.

Another advantage of the invention is to a modular saw machine, which can be quickly transform one type of saw machine to another type saw machine.

Another advantage of the invention is to a modular saw machine, which does not require to alter the original structural design of the power saw machine, so as to minimize the manufacturing cost of the modular saw machine incorporating with different implements.

Another advantage of the invention is to a modular saw machine, wherein no expensive or complicated structure is required to employ in the present invention in order to achieve the above mentioned objects. Therefore, the present invention successfully provides an economic and efficient solution for providing an environment friendly configuration for the modular saw machine being transformed among the portable hand-held, the fixed cutting-head, and the cutting-head guide-by-rail saw system.

Additional advantages and features of the invention will become apparent from the description which follows, and may be realized by means of the instrumentalities and combinations particular point out in the appended claims.

According to the present invention, the foregoing and other objects and advantages are attained by a saw machine system, comprising a modular saw machine and a plurality of saw machine implements.

The modular saw machine comprises a cutting tool guard, a driving motor coupled to the cutting tool guard and a cutting tool driven to rotate by the driving motor, wherein the modular saw machine is selectively and detachably coupled to the saw machine implements to transform one type of saw machine to another saw machine.

In accordance with another aspect of the invention, the present invention comprises a method of transforming a saw machine system among different configurations, comprising the following steps.

(A) Selectively couple a modular saw machine to one of a plurality of saw machine implements comprising a portable hand-held saw machine implement, a fixed-head saw machine implement, and a cutting-head guide-by-rail saw machine implement, wherein when the modular saw machine is detachably coupled to the portable hand-held saw machine implement, a portable hand-held saw machine is formed, wherein when the modular saw machine is detachably coupled to the fixed-head saw machine implement, a fixed-head saw machine is formed, wherein when modular saw machine is detachably coupled to the cutting-head guide-by-rail saw machine implement, a cutting-head guide-by-rail saw machine is formed.

(B) Transform one type of saw machine to another saw machine by detaching the modular saw machine from one of the saw machine implements and coupling the modular saw machine to another the saw machine implement.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a modular saw machine according to a preferred embodiment of the present invention.

FIG. 2 is a side view of the modular saw machine according to the preferred embodiment of the present invention, illustrating before and after attaching to a portable hand-held saw machine implement.

FIG. 3 is a perspective view of the modular saw machine according to the preferred embodiment of the present invention, fully mounted to a portable hand-held saw machine implement, functioning as a conventional hand-held saw machine. It is making unguided cut on a partial view of a work piece.

FIG. 4 is a perspective view of the modular saw machine according to the preferred embodiment of the present invention, fully mounted to a hand-held saw machine implement, functioning as a conventional vacuum anchored strut guided portable hand-held saw machine typically used for making circular cuts on a work piece.

FIG. 5 is a side view of the conventional fixed cutting-head saw machine.

FIG. 6 is a side view of the modular saw machine according to the preferred embodiment of the present invention, illustrating before and after attaching to a fixed cutting-head saw machine implement.

FIG. 7 is a side view of the conventional cutting-head guide-by-rail saw machine.

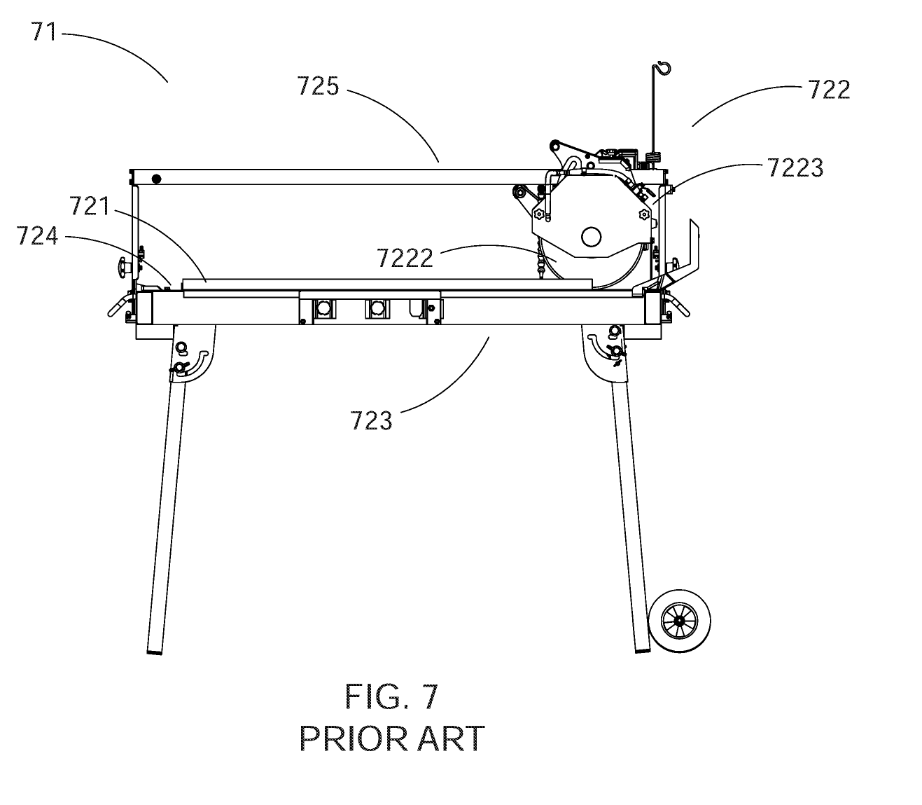

FIG. 8 is a side view of the modular saw machine according to the preferred embodiment of the present invention, illustrating before and after attaching to a cutting-head guide-by-rail saw machine implement.

FIG. 9 is a side view of the modular saw machine according to the preferred embodiment of the present invention, illustrating after fully attaching to a cutting-head guide-by-rail saw machine implement, illustrating operation of the saw machine like that of a conventional cutting-head guide-by-rail saw machine.

FIG. 10 is a perspective view of the modular saw machine according to the preferred embodiment of the present invention, illustrating after fully attaching to a cutting-head guide-by-rail saw machine implement, illustrating operation of the saw machine like that of a conventional cutting-head guide-by-rail saw machine.

FIG. 11 is a perspective view of the modular saw machine according to the preferred embodiment of the present invention, illustrating after fully attaching to a cutting-head guide-by-rail saw machine implement, illustrating alternative operation of the saw machine like that of a conventional cutting-head guide-by-rail saw machine.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

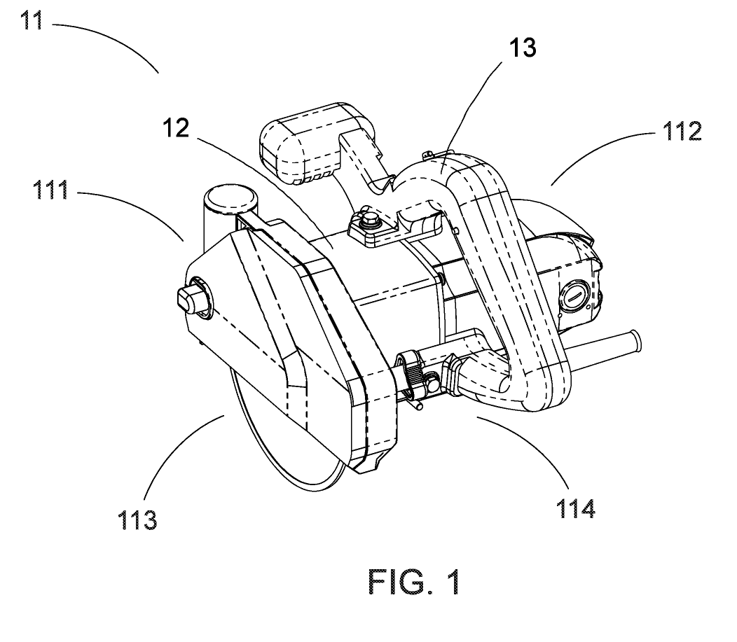

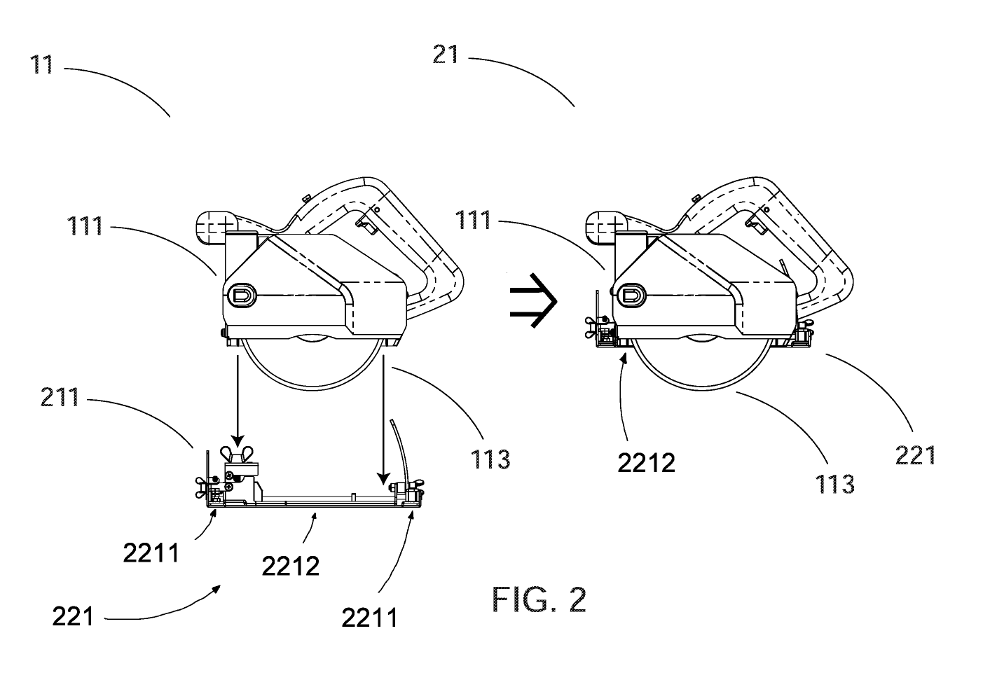

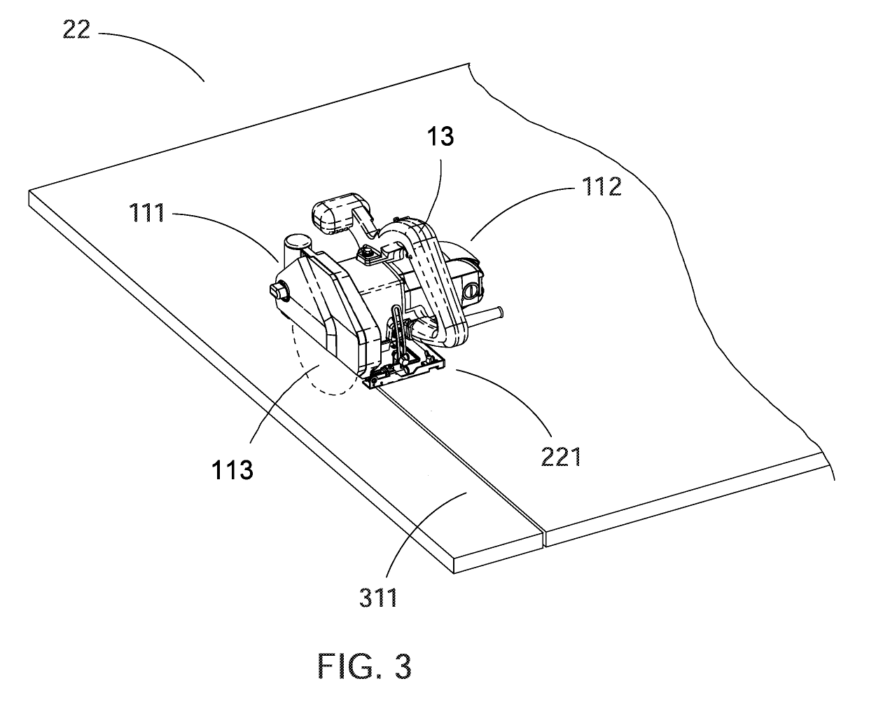

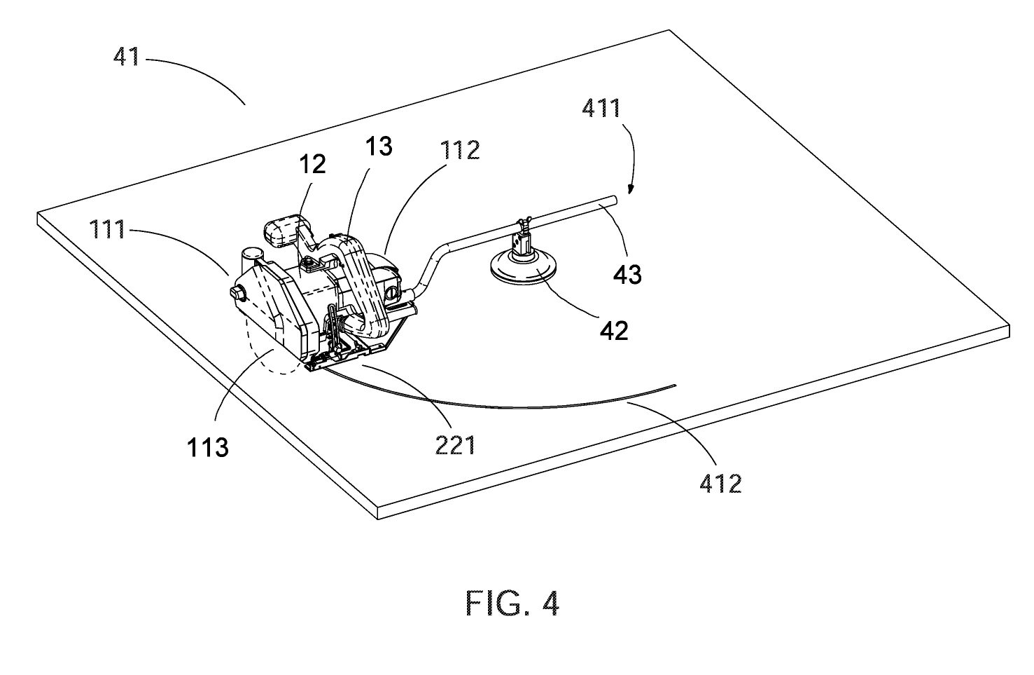

Referring to FIGS. 1, 2, 3 and 4 of the drawings, a modular saw machine 11 of the preferred embodiment of the present invention comprises a frame 12 which comprises a cutting tool guard 111, a driving motor 112, a cutting tool 113, and a quick mounting arrangement 114. Accordingly, the driving motor 112 is coupled to the frame 12 at a position adjacent to the driving tool guard 111. The cutting tool 113, such as a cutting blade, is partially received in the driving tool guard 111 and is driven to rotate by the driving motor 112. Preferably, the cutting tool 113 is replaceably coupled to the frame 12, such that a proper cutting tool can be used for a particular work piece. The modular saw machine 11 further comprises a handle frame 13 coupled at the frame to form a hand-held device. In operation when it is necessary that the saw machine be used as a portable hand-held saw machine 21, a hand-held saw machine implement 211 is needed to attach to the modular saw machine 11 via the quick mounting arrangement 114. The quick mounting arrangement 114 is provided at the frame 12. When fully attached the portable hand-held saw machine 21, will have the support of a skid 221 similar to that of a conventional portable hand-held saw machine so that it can make cuts anywhere on a flat work piece 311. The skid 221 has an elongated structure and defines two coupling ends 2211 detachably coupled to the frame 12 via the quick mounting arrangement 114, with hand screws as an example. The skid 221 further has a flat bottom surface 2212 arranged for laying on the flat work piece 311, wherein a portion of the cutting tool 113 is received in the cutting tool guard 111 and a portion of the cutting tool 113 is extended through the flat bottom surface 2212 of the skid 221. Therefore, when the flat bottom surface 2212 of the skid 221 is laid and slid on the flat work piece 311, the cutting tool 113 cuts on the flat work piece 311. An alternate embodiment of the present invention is a portable hand-held saw machine implement with anchor and guide strut 41 capable of guiding the saw machine to making circular cuts 412 using the assistance of an anchor and guide strut mechanism 411 to rotate at a fixed distance about a fixed point. As shown in FIG. 4, the anchor and guide strut mechanism 411 comprises an anchor strut 42 arranged for being coupled at the flat work piece 311 to define the fixed point, and a guide arm 43 having one end portion detachably coupled to the frame 12 of the modular saw machine 11 via the quick mounting arrangement 114 and an opposed end portion adjustably and rotatably coupled at the anchor strut 42 to selectively adjust a distance between the anchor strut 42 and the cutting tool 113. Accordingly, when the anchor strut 42 is coupled close to the free end of the guide arm 43, the distance between the anchor strut 42 and the cutting tool 113 will be maximized. When the anchor strut 42 is coupled away from the free end of the guide arm 43, the distance between the anchor strut and the cutting tool 113 will be reduced. Therefore, by selectively adjusting the distance between the anchor strut 42 and the cutting tool 113, the circular cut 412 can be made by sliding the modular saw machine 11 on the flat work piece around the anchor strut 42 via the guide arm 43.

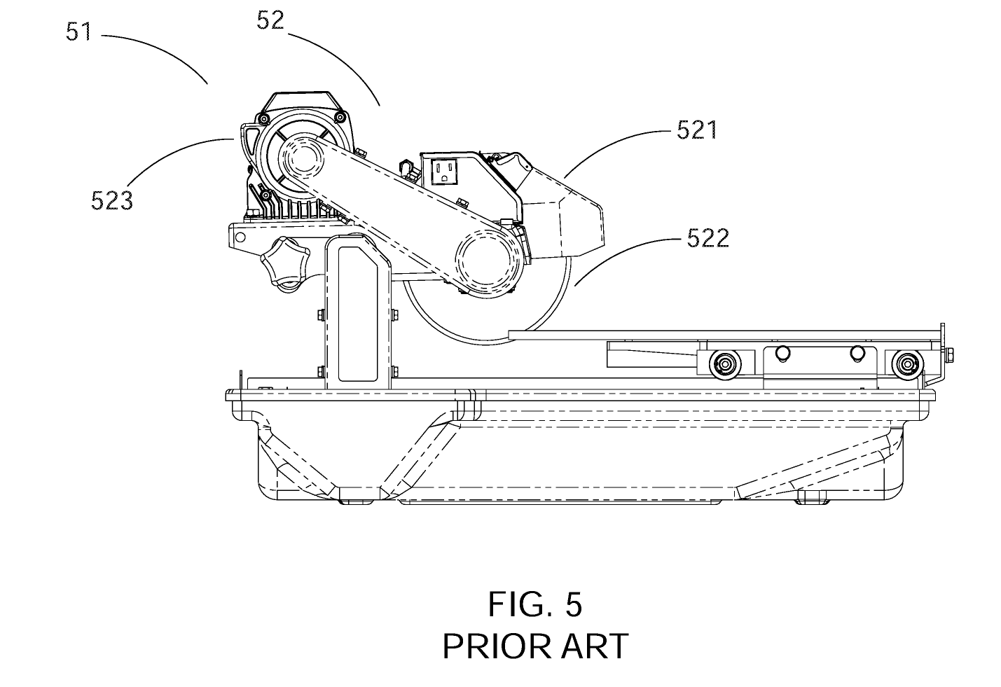

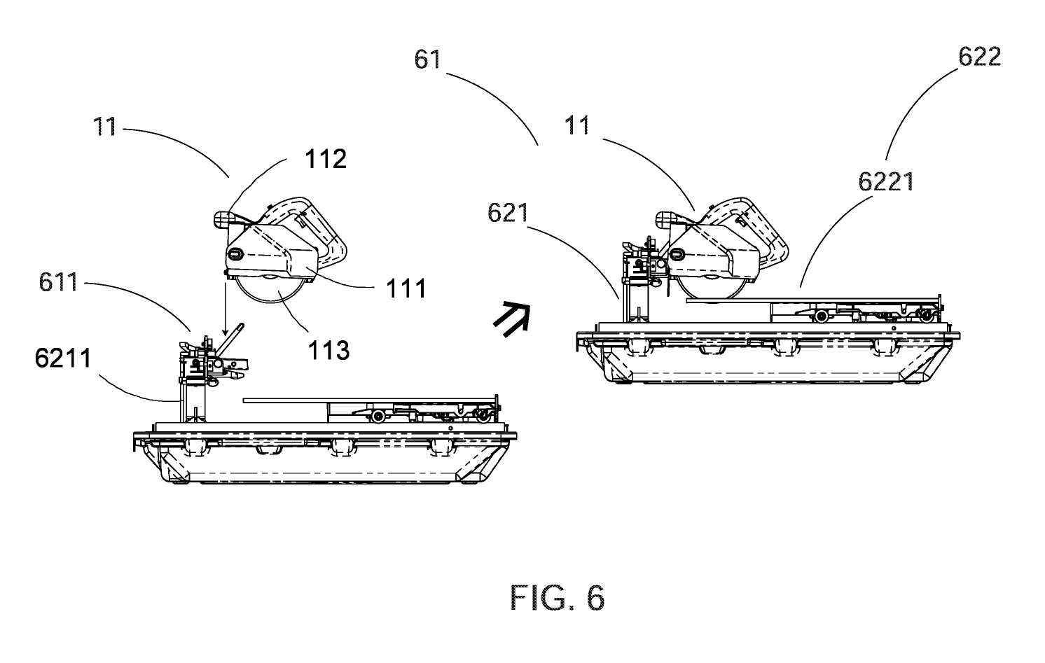

Referring to FIG. 6 of the drawings, when it is necessary that the modular saw machine 11 of the preferred embodiment of the present invention be used like a conventional fixed-head saw machine 51 in FIG. 5, a fixed-head saw machine implement 611 is necessary. The fixed-head saw machine implement 611 comprises a table frame 621 and a cutting table 622 slidably mounted on the table frame 621. The modular saw machine 11 is supported above the cutting table 622 and the work piece 6221 thereon. The modular saw machine 11 is attached to the table frame 621. Accordingly, the table frame 621 has a supporting arm 6211, wherein the modular saw machine 11 is detachably supported at a top end of the supporting arm 6211 so as to support the modular saw machine 11 above the cutting table 622. The benefits of this fixed-head saw machine 61 is its relatively small size and the accuracy of each cut due to the cutting table 622 being securely guided by the table frame 621 coupled by the cutting head 52 being fixed to the table frame 621. In addition, this design is compact as the work piece 6221 is being fed into the cutting tool 522 so typically is of a smaller size to maintain stability.

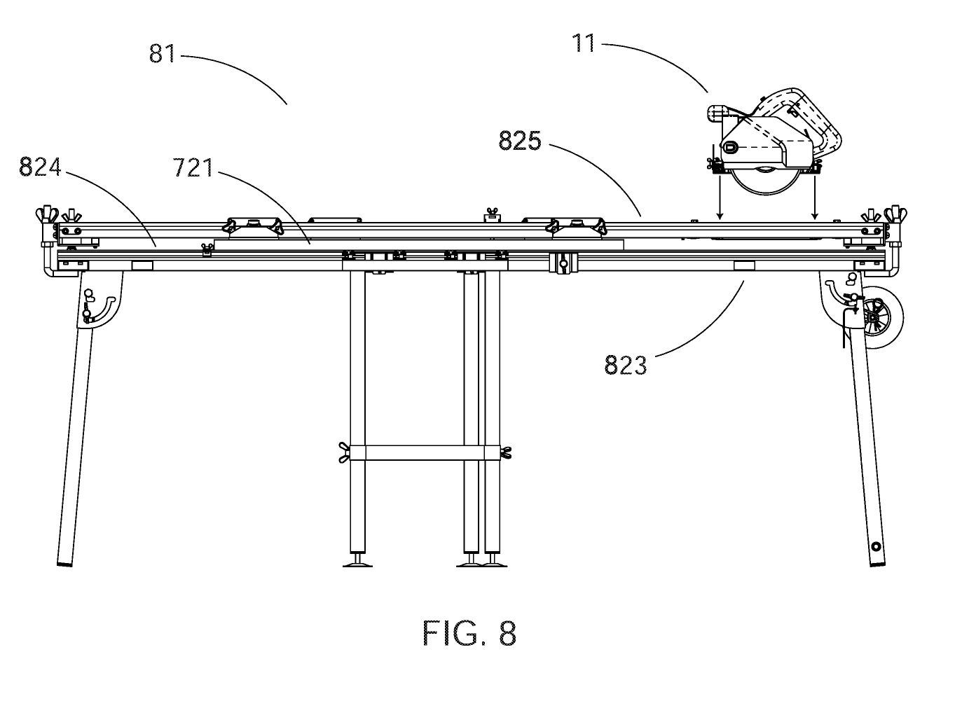

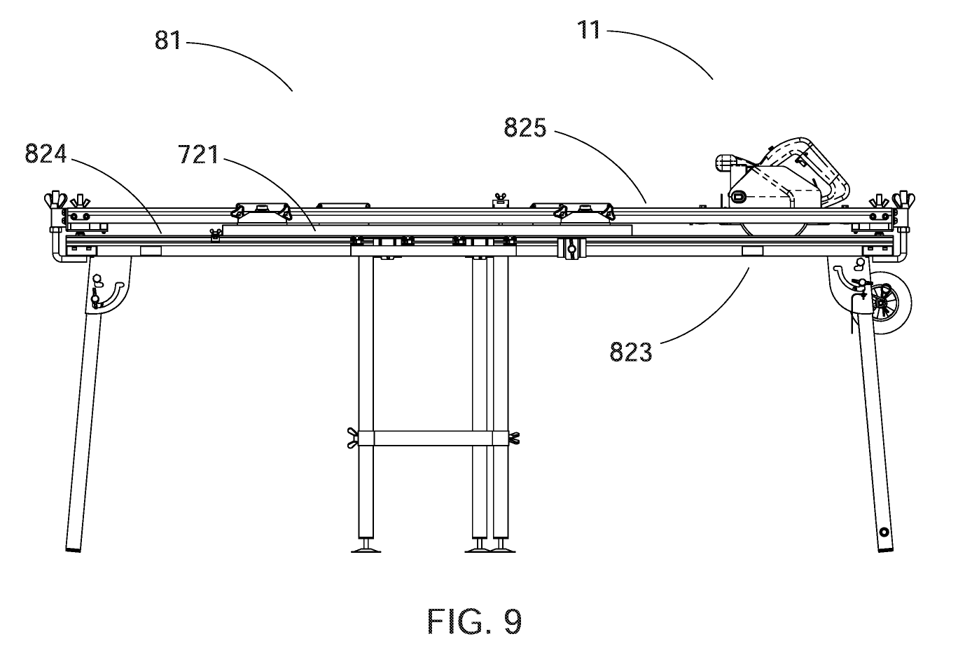

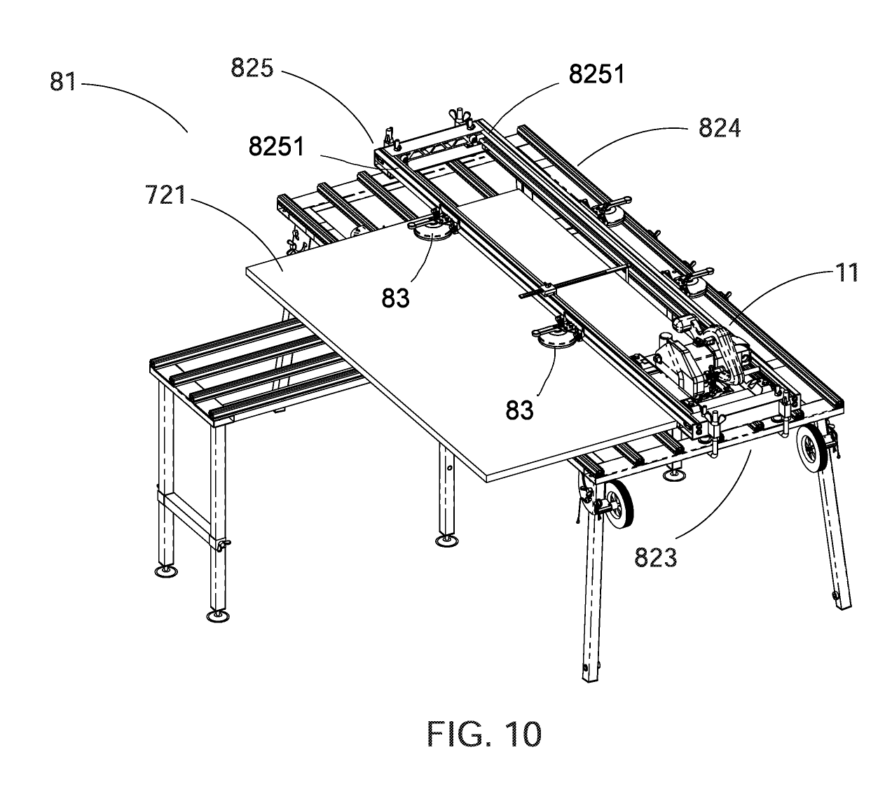

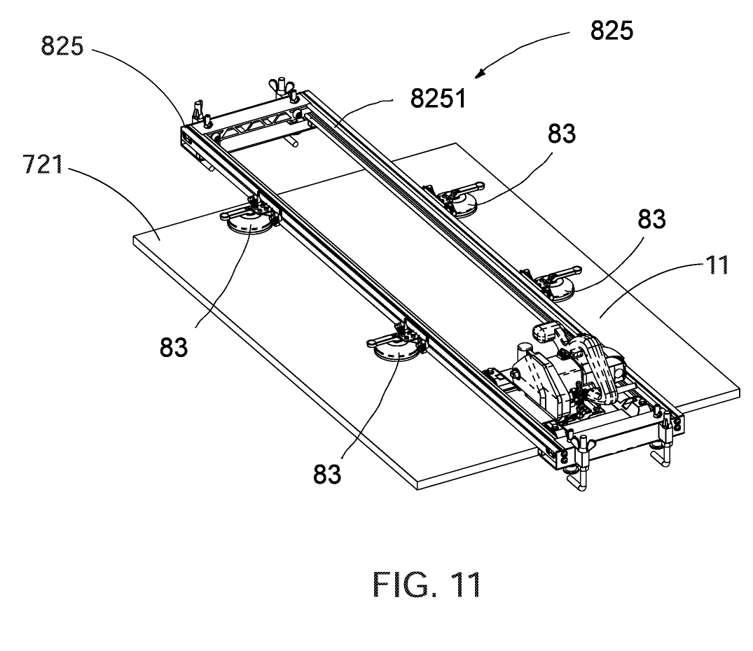

Referring to FIGS. 8, 9, 10 and 11 of the drawings, when it is necessary to work on a work piece 721 of a substantial size, the modular saw machine 11 of the preferred embodiment of the present invention should use the cutting-head guide-by-rail saw machine implement 81. The cutting-head guide-by-rail saw machine implement 81 with the modular saw machine 11 is lighter than the conventional cutting-head guide-by-rail saw machine 71. The cutting-head guide-by-rail saw machine implement 81 comprises a cutting table frame 823, a cutting table 824 supported on the cutting table frame 823 to elevate the cutting table 824, and a cutting head guide rail 825 coupled on the cutting table 824. Unlike the conventional saw machine 71 the cutting table frame 823 and the cutting table 824 are essentially different from the conventional table frame 723 and the conventional cutting table 724. During use the work piece 721 is placed on the cutting table frame 823, the cutting frame's 823 size gives this system the flexibility of almost cutting any length work piece like the portable hand-held saw machine 22, but with improved accuracy. The guide rail 825 and work piece is fixed together through the use of anchors 83 and the attached modular saw machine 11 is slidably steered by the cutting head guide rail 825 through the entire cut. Therefore, the distance between the cutting head guide rail 825 and the work piece 721 will be minimized. Via the anchors 83, the work piece 721 will be stationary and immovable on the cutting table 824 to prevent any unwanted movement when the modular saw machine 11 is slidably steered by the cutting head guide rail 825 during the cutting operation. As shown in FIG. 10, the cutting head guide rail 825 comprises two guide arms 8251 extended parallel with each other, wherein the modular saw machine 11 is slidably coupled between the guide arms 8251 to ensure the stable sliding movement of the modular saw machine 11 during the cutting operation. One or more of the anchors 83 are coupled to at least one of the guide arms 8251 to retain the work piece on the cutting table 724. An alternate embodiment of the present invention is a cutting-head guide-by-rail saw machine system without the cutting table frame 823 allowing for better work place flexibility, as shown in FIG. 11.

Accordingly, the present invention also provides a method of transforming a saw machine system among different configurations, comprising the following steps.

(A) Selectively couple a modular saw machine to one of the saw machine implements. In one embodiment, when the modular saw machine is detachably coupled to the portable hand-held saw machine implement, the portable hand-held saw machine is formed as one of the configurations. When the modular saw machine is detachably coupled to the fixed-head saw machine implement, the fixed-head saw machine is formed as another configuration. When modular saw machine is detachably coupled to the cutting-head guide-by-rail saw machine implement, the cutting-head guide-by-rail saw machine is formed as the third configuration.

(B) Transform one type of saw machine to another saw machine by detaching the modular saw machine from one of the saw machine implements and coupling the modular saw machine to another the saw machine implement. In other words, when the operator wants to transform the portable hand-held saw machine to the fixed-head saw machine, the operator can simply detach the modular saw machine from the portable hand-held saw machine implement and couple the modular saw machine to the fixed-head saw machine implement to form the fixed-head saw machine. Therefore, the saw machine system of the present invention is considered as a all-in-one saw machine to provide different cutting needs.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A saw machine system, comprising:
a modular saw machine which comprises a cutting tool guard, a driving motor coupled to said cutting tool guard and a cutting tool driven to rotate by said driving motor; and
a plurality of saw machine implements, wherein said modular saw machine is selectively and detachably coupled to said saw machine implements to transform one type of saw machine to another saw machine.

2. The saw machine system, as recited in claim 1, wherein one of said saw machine implements comprises a portable hand-held saw machine implement, wherein said modular saw machine is detachably coupled to said portable hand-held saw machine implement to form a portable hand-held saw machine.

3. The saw machine system, as recited in claim 2, wherein said portable hand-held saw machine implement comprises a skid for making cuts on a flat work piece when said skid is coupled to said modular saw machine, wherein said skid has a flat bottom surface for laying on the flat work piece, wherein a portion of said cutting tool is extended through said flat bottom surface of said bottom surface for making cuts of the flat work piece.

4. The saw machine system, as recited in claim 2, wherein said portable hand-held saw machine implement comprises an anchor and guide strut mechanism for making circular cuts on a work piece, wherein said anchor and guide strut mechanism comprises an anchor strut arranged for being coupled at the work piece to define a fixed point, and a guide arm having one end portion detachably coupled to said modular saw machine and an opposed end portion adjustably and rotatably coupled at said anchor strut to selectively adjust a distance between said anchor strut and said cutting tool.

5. The saw machine system, as recited in claim 1, wherein one of said saw machine implements comprises a fixed-head saw machine implement, wherein said modular saw machine is detachably coupled to said fixed-head saw machine implement to form a fixed-head saw machine.

6. The saw machine system, as recited in claim 5, wherein said fixed-head saw machine implement comprises a table frame and a cutting table slidably mounted on the table frame, wherein said modular saw machine is detachably coupled at said table frame above said cutting table.

7. The saw machine system, as recited in claim 1, wherein one of said saw machine implements comprises a cutting-head guide-by-rail saw machine implement, wherein said modular saw machine is detachably coupled to said cutting-head guide-by-rail saw machine implement to form a cutting-head guide-by-rail saw machine.

8. The saw machine system, as recited in claim 7, wherein said cutting-head guide-by-rail saw machine implement comprises a cutting table and a cutting head guide rail coupled on said cutting table, wherein said modular saw machine is detachably and slidably coupled at said cutting head guide rail for making cuts of a work piece on said cutting table.

9. The saw machine system, as recited in claim 8, wherein said cutting-head guide-by-rail saw machine implement further comprises one or more anchors coupled at said cutting head guide rail for retaining the work piece on said cutting table.

10. The saw machine system, as recited in claim 8, wherein said cutting head guide rail comprises two guide arms extended parallel with each other, wherein said modular saw machine is slidably coupled between said guide arms to ensure a stable sliding movement of said modular saw machine.

11. The saw machine system, as recited in claim 8, wherein said cutting-head guide-by-rail saw machine implement further comprises a cutting table frame that said cutting table is supported on said cutting table frame to elevate said cutting table.

12. The saw machine system, as recited in claim 1, wherein said modular saw machine further comprises a handle frame coupled thereat to form a hand-held device.

13. The saw machine system, as recited in claim 1, wherein said cutting tool is replaceable.

14. A saw machine system, comprising:
a modular saw machine which comprises a cutting tool; and
an implement set which comprises a portable hand-held saw machine implement, a fixed-head saw machine implement, and a cutting-head guide-by-rail saw machine implement, wherein said modular saw machine is detachably and selectively coupled to said implement set, wherein when said modular saw machine is detachably coupled to said portable hand-held saw machine implement, a portable hand-held saw machine is formed, wherein when said modular saw machine is detachably coupled to said fixed-head saw machine implement, a fixed-head saw machine is formed, wherein when modular saw machine is detachably coupled to said cutting-head guide-by-rail saw machine implement, a cutting-head guide-by-rail saw machine is formed.

15. The saw machine system, as recited in claim 14, wherein said portable hand-held saw machine implement comprises a skid for making cuts on a work piece, and an anchor and guide strut mechanism for making circular cuts on the work piece.

16. The saw machine system, as recited in claim 15, wherein said fixed-head saw machine implement comprises a table frame and a cutting table slidably mounted on the table frame, wherein said modular saw machine is detachably coupled at said table frame above said cutting table.

17. The saw machine system, as recited in claim 16, wherein said cutting-head guide-by-rail saw machine implement comprises a cutting table, a cutting head guide rail coupled on said cutting table, and one or more anchors coupled at said cutting head guide rail for retaining the work piece on said cutting table, wherein said modular saw machine is detachably and slidably coupled at said cutting head guide rail for making cuts of the work piece on said cutting table.

18. The saw machine system, as recited in claim 17, wherein said cutting head guide rail comprises two guide arms extended parallel with each other, wherein said modular saw machine is slidably coupled between said guide arms to ensure a stable sliding movement of said modular saw machine.

19. The saw machine system, as recited in claim 18, wherein said cutting tool is replaceable.

20. A method of transforming a saw machine system among different configurations, comprising the steps of:
(a) selectively coupling a modular saw machine to one of a plurality of saw machine implements comprising a portable hand-held saw machine implement, a fixed-head saw machine implement, and a cutting-head guide-by-rail saw machine implement, wherein when said modular saw machine is detachably coupled to said portable hand-held saw machine implement, a portable hand-held saw machine is formed, wherein when said modular saw machine is detachably coupled to said fixed-head saw machine implement, a fixed-head saw machine is formed, wherein when modular saw machine is detachably coupled to said cutting-head guide-by-rail saw machine implement, a cutting-head guide-by-rail saw machine is formed; and
(b) transforming one type of saw machine to another saw machine by detaching said modular saw machine from one of said saw machine implements and coupling said modular saw machine to another said saw machine implement.
